(19) United States
(12) Patent Application Publication
(10) Pub. No.: US 2023/0075159 A1
(43) Pub. Date: Mar. 9, 2023

(54) INTELLIGENT AUTOMATIC PROCESSING APPARATUS FOR SPOKE HOLE OF BICYCLE RIM

(71) Applicant: ALEX GLOBAL TECHNOLOGY, INC., Tainan City (TW)

(72) Inventor: Ming-Tse Hung, Tainan City (TW)

(21) Appl. No.: 17/470,285

(22) Filed: Sep. 9, 2021

(51) Int. Cl. B23B 39/08

(52) U.S. Cl. CPC B23B 39/08; B60B 2310/226; B60B 1/043

(57) ABSTRACT

An intelligent automatic processing apparatus for spoke holes of bicycle rims is revealed. The apparatus includes a seat pivotally connected to a machine body and provided with a rotary base. A rim is clamped and fixed by clamping jaws on the rotary base and a control unit drives an incline unit to incline the seat connected at an angle desired for control of slopes of holes being drilled. The control unit also drives a rotary indexing power source to rotate the rotary base at different angles according to the numbers and positions of spoke holes desired. Thus a drilling assembly drills the spoke holes on the rim. Thereby the spoke holes with various angles can be drilled on different positions of the rim by the control unit which adjusts positions and inclination angles of the rim accurately. Therefore, the drilling of the spoke holes is more convenient.

### BACKGROUND OF THE INVENTION

### Field of the Invention

The present invention relates to a processing apparatus for bicycle rims, especially to an intelligent automatic processing apparatus for spoke holes of bicycle rims which is adapted to drill spoke holes at different positions and angles of various bicycle rims and make drilling of the spoke holes on the rim more convenient.

### Description of Related Art

Refer to Taiwanese Pat. Pub. No. 1258396B “bicycle rim drilling machine”, Taiwanese Pat. Pub. No. M450439U “composite rim drilling machine”, Taiwanese Pat. Pub. No. M369805U “rim drilling machine”, Chinese Pat. Pub. No. 201524819U “rim drilling machine”, and Chinese Pat. Pub. No. 206153612U “5-axis drilling machine for aluminum rims”, bicycle rim drilling machines available now mainly includes a plurality of drilling unit arranged around a machine base and a holding unit disposed on a center of the machine base. In order to drill holes on a rim, the rim is fixed by the holding unit and the plurality of drilling units are driven to move toward the rim synchronously to form corresponding spoke holes on the periphery of the rim.

The number of the drilling units disposed on bicycle rim drilling machine is determined according to the number of spoke holes users need. By the holding unit or a tool axis located at the center of the machine base being rotated an angle, holes are formed on an inner circular wall and outer circular wall of the rim and equally spaced around the rim. The traditional technique mentioned above is applied to the rim processing with equally spaced spoke holes for mass production of low-end products. However, some high-end or racing rims used in combination with hubs, the arrangement of spokes and the form of the inner circular wall are not designed in standard specifications in consideration of tension and horizontal component of force. That means the specifications of the spoke holes such as the number, the position, and the slope of the holes on the inner circular wall are all specific. Thus the prior arts mentioned above are not suitable for drilling different numbers of the spoke holes at different positions and batch production of the rims having the spoke holes with different slopes. The drilling of the spoke holes on the rim is not convenient. There is room for improvement and there is a need to provide a novel bicycle rim drilling machine.

### SUMMARY OF THE INVENTION

Therefore, it is a primary object of the present invention to provide an intelligent automatic processing apparatus for spoke holes of bicycle rims which is adapted to drill spoke holes at different positions and angles of various bicycle rims and make drilling of the spoke holes on the rim more convenient.

In order to achieve the above object, an intelligent automatic processing apparatus for spoke holes of bicycle rims according to the present invention includes a seat pivotally connected to a machine body and provided with a rotary base. While in use, a rim is clamped and fixed by clamping jaws on the rotary base. Then a control unit drives an incline unit to incline the seat connected at an angle desired for control of slopes of holes being drilled. The control unit also drives a rotary indexing power source to rotate the rotary base at different angles according to the numbers and positions of spoke holes to be drilled. Thus a drilling assembly drills the spoke holes required on the rim. Thereby the present apparatus is adapted to drill the spoke holes at different positions and angles of the rim by the control unit which adjusts the positions and inclination angles of the rim accurately. Therefore, the drilling of the spoke holes on the rim becomes more convenient.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is a front view of an embodiment according to the present invention;

FIG. 3 is a top view an embodiment according to the present invention;

FIG. 4 is a perspective view of an embodiment while in use according to the present invention;

FIG. 5 is a partial perspective view of an embodiment while in use according to the present invention;

FIG. 6 is a schematic drawing showing a double-layer rim with holes according to the present invention.

### DETAILED DESCRIPTION OF THE PREFERRED EMBODIMENT

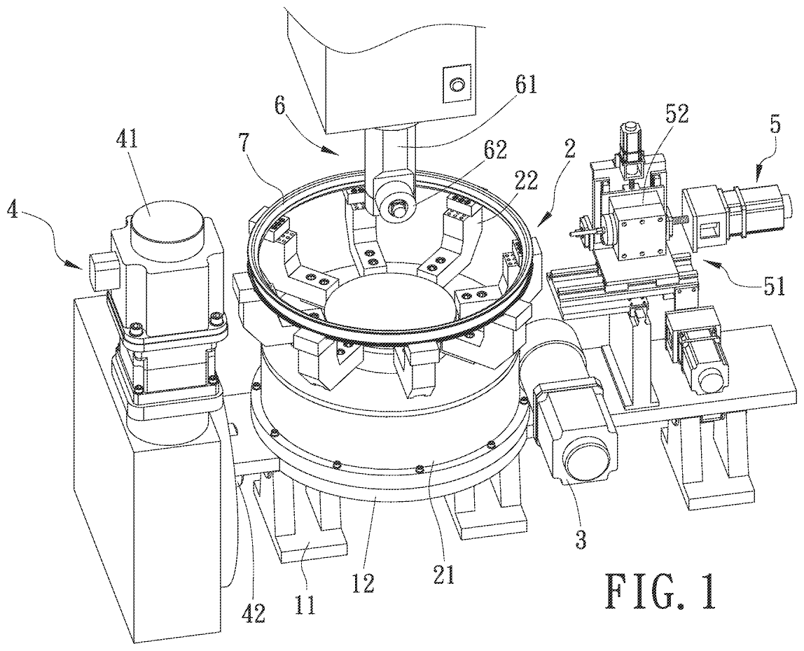

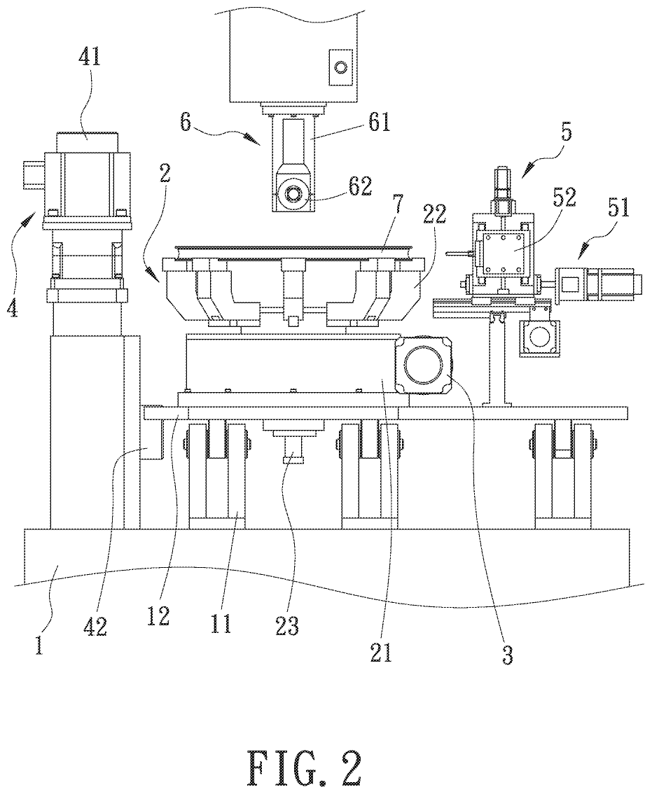

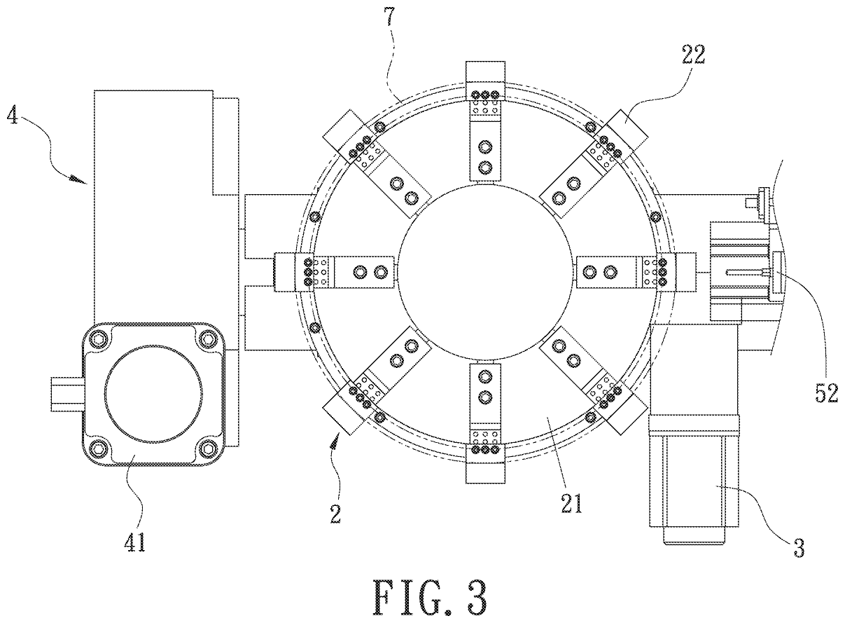

Refer to FIG. 1, FIG. 2, and FIG. 3, an intelligent automatic processing apparatus for spoke holes of a bicycle rim according to the present invention includes a machine body 1, a clamp unit 2, a rotary indexing power source 3, an incline unit 4, an outer drilling assembly 5, and an inner drilling assembly 6.

The machine body 1 is provided with a plurality of supports 11 fixed thereof, and a seat 12 disposed on the supports 11 and pivotally connected to the supports 11.

The clamp unit 2 consists of a rotary base 21 disposed over the seat 12, a plurality of clamping jaws 22 arranged around a center of the rotary base 21, and a jaw power source 23 mounted to a bottom of the seat 12 and connected to the clamping jaws 22 for transmitting power to the clamping jaws 22 so that the clamping jaws 22 are driven to open and close for catching and releasing objects. The clamp unit 2 is provided with an inner side and an outer side opposite to each other. The center of the rotary base 21 of the clamp unit 2 is the inner side while a periphery of the rotary base 21 is the outer side.

The rotary indexing power source 3 is disposed on the seat 12 and connected to the rotary base 21 of the clamp unit 2 for transmitting power to the rotary base 21 and driving the rotary base 21 to rotate with respect to the seat 12.

The inclination unit 4 is mounted to the machine body 1 and provided with a servo power source 41 connected to a rotating shaft 42 and transmitting power to the rotating shaft 42. The rotating shaft 42 is connected to the seat 12 for driving both the seat 12 and the rotary base 21 over the seat 12 to tilt forward and backward.

The outer drilling assembly 5 is located at the outer side of the clamp unit 2 and composed of a first movement module 51 arranged at the machine body 1 and a first drilling module 52 mounted to the first movement module 51. The first movement module 51 is capable of being moved, adjusted, and positioned in X, Y, and Z axes with respect to the machine body 1.

The inner drilling assembly 6 is located at the inner side of the clamp unit 2 and provided with a second movement module 61 mounted to the machine body 1 and a second drilling module 62 disposed on the second movement module 61. The second movement module 61 is capable of being moved, adjusted, and positioned in X, Y, and Z axes with respect to the machine body 1.

The jaw power source 23 of the clamp unit 2, the rotary indexing power source 3, the servo power source 41 of the inclination unit 4, the first movement module 51 and the first drilling module 52 of the outer drilling assembly 5, and the second movement module 61 and the second drilling module 62 of the inner drilling assembly 6 are connected to a control unit mounted to the machine body 1 in a wired or wireless way.

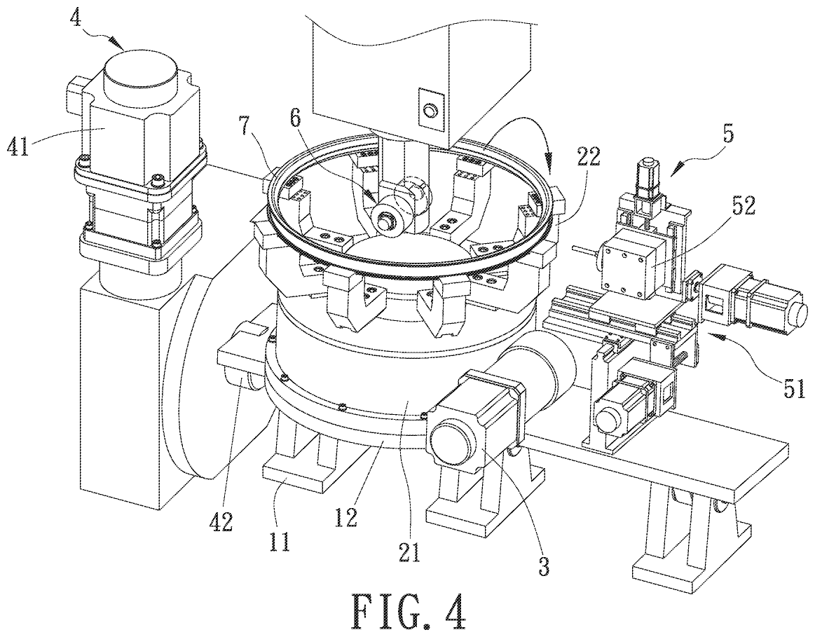

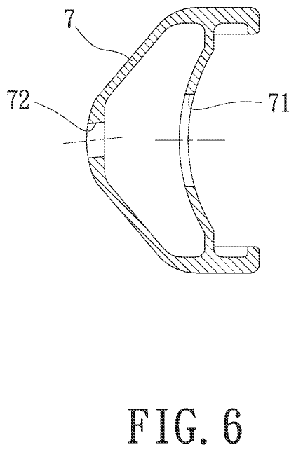

While in use, a rim 7 with an inner circular wall and an outer circular wall is arranged at the clamp unit 2 and then the control unit drives the jaw power source 23 of the clamp unit 2 to move the plurality of the clamping jaws 22 for clamping and fixing the rim 7. Also refer to FIG. 4 and FIG. 6, while drilling inner spoke holes 72 on the inner circular wall of the rim 7, the control unit drives the servo power source 41 of the inclination unit 4 to make the rotating shaft 42 rotate at a preset angle. Then the seat 12 and the rotary base 21 are driven to incline at an angle with respect to the horizontal plane so that the rim 7 clamped and fixed by the clamping jaws 22 of the clamp unit 2 is also inclined. Next the control unit drives the second movement module 61 of the inner drilling assembly 6 to move the second drilling module 62 toward the rim 7 and the inner drilling assembly 6 drills the inner circular wall of the rim 7 in the horizontal direction to form the inner spoke holes 72 with preset inclination angles on the inner circular wall of the rim 7. By setting an angle of clockwise and counterclockwise rotation of the rotating shaft 42 driven by the servo power source 41 of the inclination unit 4, the rim 7 is inclined upward or downward with respect to the inner drilling assembly 6 so that the inner spoke holes 72 with certain slopes are further formed on the inner circular wall of the rim 7 by drilling. Therefore, spokes have good tension and horizontal component of force while being mounted in the inner spoke holes 72 and combined with hubs to form a wheel set.

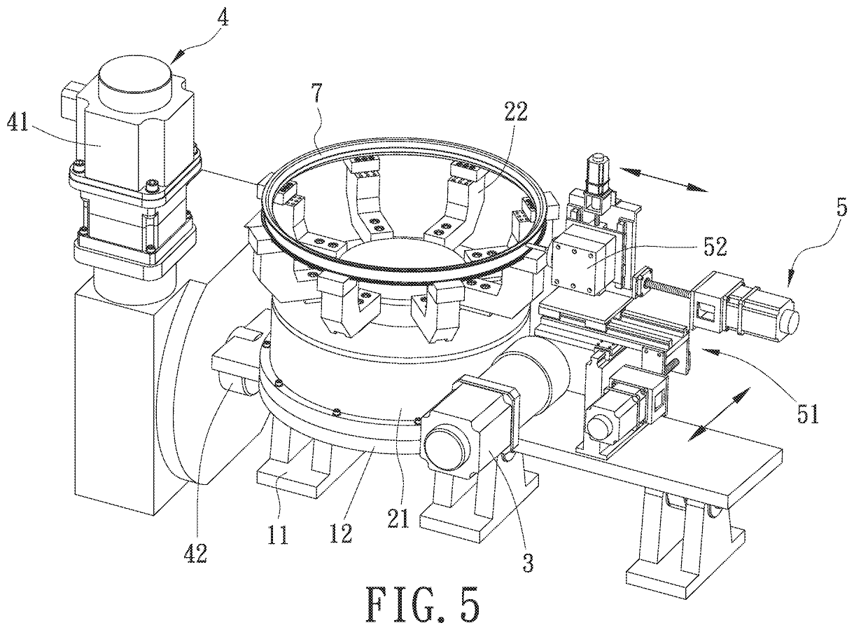

Also refer to FIG. 5, while users intend to drill outer spoke holes 71 on the outer circular wall, the control unit drives the first movement module 51 of the outer drilling assembly 5 to move for adjustment and thus the first drilling module 52 is further driven to move toward the rim 7 for drilling an outer spoke hole 71 on the outer circular wall of the rim 7. Then the control unit drives the first movement module 51 of the outer drilling assembly 5 again to turn the first drilling module 52 back to the original position. In order to drill another hole on the second position, the control unit drives the rotary indexing power source 3 to move for rotating the rotary base 21 a preset angle horizontally and positioning the rotary base 21 there. Thereby the inner drilling assembly 6 and the outer drilling assembly 5 drill the rim 7 to form the inner spoke holes 72 and the outer spoke holes 71 respectively at positions needed in turn under control of the control unit.

The position of each of the holes being drilled on the rim 7 is formed in turn by the rotary indexing power source 3 which drives the rotary base 21 to rotate and positions the rotary base 21 there. By setting an angle of clockwise and counterclockwise rotation of the rotating shaft 42 driven by the servo power source 41 of the inclination unit 4, the inner spoke holes 72 formed on the inner circular wall of the rim 7 by the inner drilling assembly 6 are inclined at different angles (having different slopes). Moreover, the outer drilling assembly 5 and the inner drilling assembly 6 are not only drilling the spoke holes on the rim 7 accurately but also adapted to drill the spoke holes at different positions and with various inclination angles in a batch manner due to tri-axial displacement, adjustment, and positioning in X, Y, and Z axes of the first movement module 51 and the second movement module 61. The drilling of the inner spoke holes 72 and the outer spoke holes 71 can be controlled by programming. The control unit can firstly control the inner drilling assembly 6 to complete the drilling of the inner spoke holes 72 and then the outer drilling assembly 5 to drill the outer spoke holes 71. Or the control unit firstly controls the outer drilling assembly 5 to complete the drilling of the outer spoke holes 71 and then the inner drilling assembly 6 to drill the inner spoke holes 72. Or the outer spoke holes 71 and the inner spoke holes 72 are drilled at the same time under control of the control unit for saving processing time.

In summary, the present invention has the following advantages:
1. The present intelligent automatic processing apparatus for spoke holes of bicycle rims is adapted to drill the spoke holes at different positions and with various inclination angles by the control unit which adjusts the position and the inclination angle of the rim accurately. Thus the hole drilling of the rim is more convenient.
2. By the rotary indexing power source which drives the rotary base to rotate and positions the rotary base there, the positions of the respective holes being drilled on the rim are controlled in turn accurately.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. An intelligent automatic processing apparatus for spoke holes of bicycle rims comprising:
a machine body provided with a plurality of supports fixed thereof and a seat which is disposed on the supports and pivotally connected to the supports;
a clamp unit having a rotary base disposed over the seat, a plurality of clamping jaws arranged around a center of the rotary base, and a jaw power source mounted to a bottom of the seat and connected to the clamping jaws for transmitting power to the clamping jaws; the clamp unit further including an inner side and an outer side arranged opposite to each other while the inner side is a center of the rotary base of the clamp unit and the outer side is a periphery of the rotary base;
a rotary indexing power source which is disposed on the seat and connected to the rotary base of the clamp unit for transmitting power to the rotary base and driving the rotary base to rotate;
an incline unit mounted to the machine body and provided with a servo power source connected to a rotating shaft and transmitting power to the rotating shaft; the rotating shaft connected to the seat for driving the seat to incline;
an outer drilling assembly located at the outer side of the clamp unit and having a first movement module which is arranged at the machine body and provided with a first drilling module;
an inner drilling assembly located at the inner side of the clamp unit and including a second movement module which is mounted to the machine body and provided with a second drilling module.

2. The intelligent automatic processing apparatus for spoke holes of bicycle rims as claimed in claim 1, wherein the first movement module of the outer drilling assembly is a tri-axial movement module moveable in X, Y, and Z axes.

3. The intelligent automatic processing apparatus for spoke holes of bicycle rims as claimed in claim 1, wherein the second movement module of the inner drilling assembly is a tri-axial movement module moveable in X, Y, and Z axes.
